(19) United States
(12) Patent Application Publication
(10) Pub. No.: US 2026/0251078 A1
(43) Pub. Date: Aug. 27, 2026

(54) TURBOMACHINE

(71) Applicant: KAWASAKI JUKOGYO KABUSHIKI KAISHA, Kobe-shi, Hyogo (JP)

(72) Inventors: Ryota TAKEUCHI, Kobe-shi (JP); Kenta UEYAMA, Kobe-shi (JP); Toshimasa MIURA, Kobe-shi (JP); Noritaka NAKAMURA, Kobe-shi (JP); Akihito SAYO, Kobe-shi (JP)

(73) Assignee: KAWASAKI JUKOGYO KABUSHIKI KAISHA, Kobe-shi, Hyogo (JP)

(21) Appl. No.: 19/161,611

(22) PCT Filed: Feb. 27, 2024
(86) PCT No.: PCT/JP2024/007101

§ 371 Date: Sep. 2, 2025

(30) Foreign Application Priority Data
Mar. 3, 2023 (JP) 2023-032849

(51) Int. Cl. F01D 25/22; F01D 25/16; F01D 25/18

(52) U.S. Cl. CPC F01D 25/22; F01D 25/166; F01D 25/186; F05D 2240/53; F05D 2270/301

(57) ABSTRACT

A turbomachine includes: a rotating shaft; a casing including a liquid chamber and a gas chamber in which the rotating shaft extends; a hydrostatic liquid bearing located in the liquid chamber and supporting the rotating shaft through a lubricating liquid supplied to a bearing clearance between the hydrostatic liquid bearing and the rotating shaft; and a hydrostatic gas bearing located in the gas chamber and supporting the rotating shaft through a lubricating gas supplied to a bearing clearance between the hydrostatic gas bearing and the rotating shaft.

### CROSS-REFERENCE TO RELATED APPLICATIONS

This is a U.S. National Phase Application of PCT/JP2024/007101 filed on Feb. 27, 2024, which designates the United States and claims priority to Japanese Patent Application No. 2023-032849, filed on Mar. 3, 2023. The disclosure of the prior applications is hereby incorporated by reference herein in its entirety.

### TECHNICAL FIELD

The present disclosure relates to a turbomachine that uses a cryogenic liquid as a working fluid.

### BACKGROUND ART

A turbomachine continuously performs energy conversion between fluid energy and mechanical energy. The turbomachine that serves as a pump is utilized to transfer a fluid or increase the pressure of the fluid. Moreover, the turbomachine that serves as a turbine is utilized to reduce the pressure of the fluid or collect energy from fluid.

It is known that to extend the life of the turbomachine that uses a cryogenic liquid, such as a liquefied gas, as a working fluid, the turbomachine includes a hydrostatic liquid bearing as a bearing. For example, PTL 1 discloses a pump apparatus that is one type of turbomachine and is used in a state of sinking in a storage tank when the pump apparatus pumps up the liquefied gas from the storage tank. This pump apparatus includes the hydrostatic liquid bearing that supports a rotating shaft. Part of the liquefied gas separated from the mainstream of the working fluid is supplied to the hydrostatic liquid bearing as a lubricating liquid, and the lubricating liquid discharged from the hydrostatic liquid bearing is made to return to the mainstream of the working fluid.

### CITATION LIST

### Patent Literature

PTL 1: Japanese Laid-Open Patent Application Publication No. 2005-320906

### SUMMARY OF INVENTION

### Technical Problem

In the configuration of PTL 1, all of hydrostatic bearings included in the pump apparatus are the hydrostatic liquid bearings. A high-pressure liquefied gas which has been increased in pressure by the bladed wheel and discharged through a discharge port is supplied as the lubricating liquid to these hydrostatic liquid bearings. Bearing stiffness of the hydrostatic liquid bearing is proportional to supply pressure of the lubricating liquid supplied to the hydrostatic liquid bearing. However, at the start and end of the rotation of the rotating shaft, the supply pressure of the lubricating liquid which is adequate to levitate the rotating shaft is not generated, and therefore, the rotating shaft and the bearing may contact each other and wear out.

The present disclosure was made under these circumstances, and an object of the present disclosure is to, in a turbomachine including a rotating shaft supported by a hydrostatic bearing, prevent the rotating shaft and the bearing from contacting each other at the start and end of the rotation of the rotating shaft.

### Solution to Problem

In order to solve the above problems, a turbomachine according to one aspect of the present disclosure includes:
a rotating shaft;
a casing including a liquid chamber and a gas chamber in which the rotating shaft extends;
a hydrostatic liquid bearing located in the liquid chamber and supporting the rotating shaft through a lubricating liquid supplied to a bearing clearance between the hydrostatic liquid bearing and the rotating shaft; and
a hydrostatic gas bearing located in the gas chamber and supporting the rotating shaft through a lubricating gas supplied to a bearing clearance between the hydrostatic gas bearing and the rotating shaft.

### Advantageous Effects of Invention

According to one aspect of the present disclosure, in the turbomachine including the rotating shaft supported by the hydrostatic bearing, the rotating shaft and the bearing can be prevented from contacting each other at the start and end of the rotation of the rotating shaft.

### BRIEF DESCRIPTION OF DRAWINGS

FIG. 1 is a schematic configuration diagram of a turbomachine according to Embodiment 1 of the present disclosure.

FIG. 2 is a diagram for explaining the flow of a fluid when the turbomachine shown in FIG. 1 is an expansion turbine.

FIG. 3 is a diagram for explaining the flow of the fluid when the turbomachine shown in FIG. 1 is a pump.

FIG. 4 is a schematic configuration diagram of the turbomachine according to Embodiment 2 of the present disclosure.

FIG. 5 is a diagram for explaining the flow of the fluid when the turbomachine shown in FIG. 4 is the pump.

FIG. 6 is a diagram for explaining the flow of the fluid when the turbomachine shown in FIG. 4 is the expansion turbine.

FIG. 7 is a schematic configuration diagram of the turbomachine according to Modified Example 1 of Embodiment 2 of the present disclosure.

FIG. 8 is a schematic configuration diagram of the turbomachine according to Modified Example 2 of Embodiment 2 of the present disclosure.

FIG. 9 is a diagram for explaining a hydrostatic liquid bearing that also serves as a seal.

### DESCRIPTION OF EMBODIMENTS

### Embodiment 1

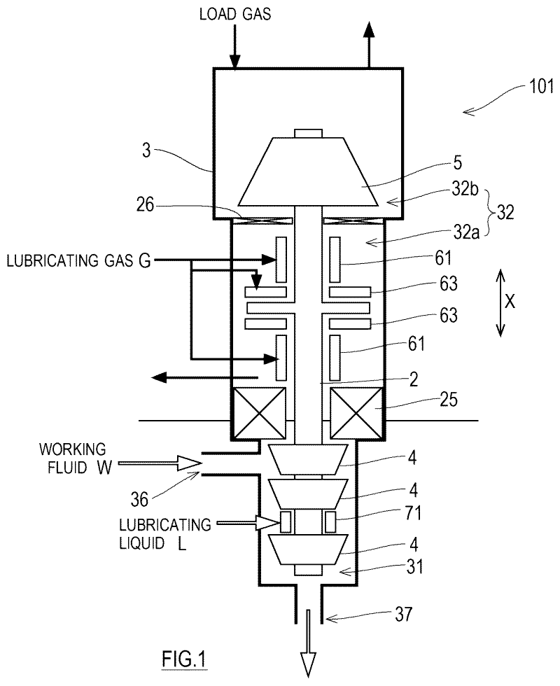

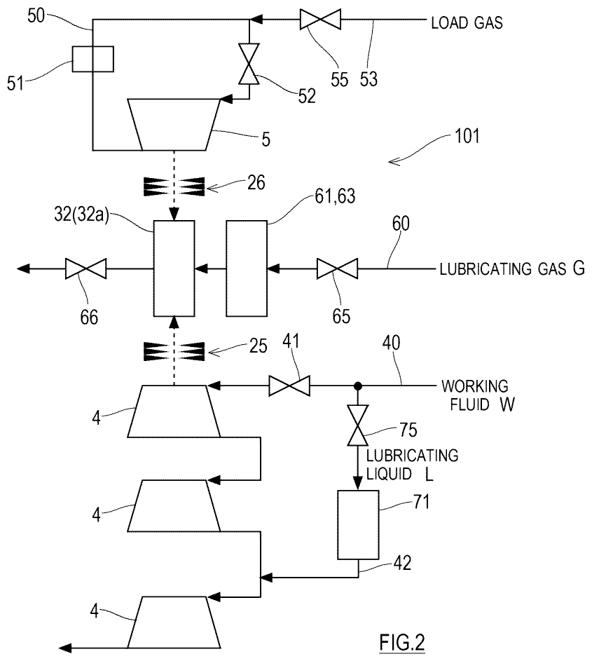

FIG. 1 is a schematic configuration diagram of a turbomachine 101 according to Embodiment 1 of the present disclosure. FIG. 2 is a diagram for explaining the flow of a fluid when the turbomachine 101 shown in FIG. 1 is an expansion turbine. In the present embodiment, the expansion turbine is adopted as one example of the turbomachine 101, and the characteristic configuration of the turbomachine 101 according to the present disclosure will be described by being applied to the expansion turbine. The expansion turbine subjects a working fluid W, which is in a cryogenic liquid state or a cryogenic gas-liquid two-phase state, to adiabatic expansion to take out part of energy of the working fluid W to the outside and liquefy the working fluid W by cooling. The working fluid W may be in a supercritical fluid state. Such expansion turbine is included in a liquefaction plant that generates a cryogenic or ultra-cryogenic liquefied gas from a gas, such as a hydrogen gas, a helium gas, or a natural gas.

As shown in FIGS. 1 and 2, the turbomachine 101 includes a casing 3 and a rotating shaft 2 accommodated in the casing 3. In the present embodiment, the rotating shaft 2 is a shaft body extending in an axial direction X that is an upper-lower direction. The casing 3 includes a liquid chamber 31 and a gas chamber 32 which are lined up in the axial direction X. The rotating shaft 2 penetrates the liquid chamber 31 and the gas chamber 32. The gas chamber 32 is divided by a seal 26, such as a labyrinth seal, into two regions which are lined up in the axial direction X and are a bearing region 32a that is a first region and a load region 32b that is a second region. The bearing region 32a is adjacent to the liquid chamber 31.

A gas-liquid seal 25 is located between the liquid chamber 31 and the gas chamber 32 in the axial direction X. The gas-liquid seal 25 seals a clearance between the rotating shaft 2 and the casing 3 in a radial direction. The gas-liquid seal 25 prevents the fluid from moving from the liquid chamber 31 to the gas chamber 32 and from the gas chamber 32 to the liquid chamber 31. The gas-liquid seal 25 has a heat insulation property and prevents heat conduction between the liquid chamber 31 and the gas chamber 32.

In the liquid chamber 31, first bladed wheels 4 are attached to the rotating shaft 2. The first bladed wheels 4 are lined up in the axial direction X., Moreover, a hydrostatic liquid bearing 71 is located in the liquid chamber 31. The hydrostatic liquid bearing 71 is a journal bearing that rotatably supports the rotating shaft 2. The turbomachine 101 shown in FIG. 1 includes three first bladed wheels 4, and the hydrostatic liquid bearing 71 is located between the first bladed wheel 4 at a second stage and the first bladed wheel 4 at a third stage in the axial direction X.

The turbomachine 101 includes a mainstream line 40 through which the mainstream of the working fluid W flows. The working fluid W flowing through the mainstream line 40 is introduced to the liquid chamber 31 through a first port 36, sequentially acts on the first bladed wheels 4, and is then discharged to the outside of the liquid chamber 31 through a second port 37. The amount of working fluid W supplied to the liquid chamber 31 is controlled by a mainstream control valve 41 located upstream of the first bladed wheel 4 at a first stage on the mainstream line 40.

A lubricating liquid L is supplied to a bearing clearance between the hydrostatic liquid bearing 71 and the rotating shaft 2. A lubricating liquid film is formed between the rotating shaft 2 and the hydrostatic liquid bearing 71 by the lubricating liquid L, and the rotating shaft 2 and the hydrostatic liquid bearing 71 are separated from each other by the lubricating liquid film and are in a non-contact state. The lubricating liquid L is a high-pressure fluid that is the same in type as the working fluid W and is in a liquid state or a gas-liquid two-phase state. For example, when the working fluid W is liquid hydrogen, the lubricating liquid L is liquid hydrogen or a gas-liquid two-phase fluid of liquid hydrogen and a hydrogen gas. Moreover, when the working fluid W is a liquefied natural gas, the lubricating liquid L is a liquefied natural gas or a gas-liquid two-phase fluid of a liquefied natural gas and a natural gas.

A lubricating liquid line 42 is connected to the mainstream line 40. In the present embodiment, an upstream end of the lubricating liquid line 42 is connected to a portion of the mainstream line 40 which is located upstream of the mainstream control valve 41, and a downstream end of the lubricating liquid line 42 is connected to a portion of the mainstream line 40 which is located between the first bladed wheel 4 at the second stage and the first bladed wheel 4 at the third stage. A lubricating liquid supply pressure control valve 75 is located at a portion of the lubricating liquid line 42 which is located upstream of the hydrostatic liquid bearing 71. The lubricating liquid line 42 extracts part of the working fluid W from the mainstream line 40, supplies the working fluid W as the lubricating liquid L to the hydrostatic liquid bearing 71 (more specifically, to the bearing clearance between the hydrostatic liquid bearing 71 and the rotating shaft 2 through the hydrostatic liquid bearing 71), and returns the lubricating liquid L, which has been used at the hydrostatic liquid bearing 71 and discharged, to the mainstream line 40. In this case, bearing stiffness of the hydrostatic liquid bearing 71 is adjusted in such a manner that the lubricating liquid supply pressure control valve 75 adjusts the pressure of the lubricating liquid L to be supplied to the hydrostatic liquid bearing 71.

The lubricating liquid line 42 is utilized to supply the lubricating liquid L to the hydrostatic liquid bearing 71 during the operation of the turbomachine 101. In addition, the lubricating liquid line 42 can be utilized to pre-cool the liquid chamber 31 and the first bladed wheels 4 before starting up the turbomachine 101. When the lubricating liquid line 42 is utilized for the pre-cooling, the mainstream control valve 41 is closed, and the lubricating liquid supply pressure control valve 75 is open. Thus, the cryogenic working fluid W is supplied to the liquid chamber 31 through the lubricating liquid line 42 to pre-cool the liquid chamber 31 and the first bladed wheels 4. In this case, the amount of working fluid W supplied is adjusted by the lubricating liquid supply pressure control valve 75 to such a degree that the rotating shaft 2 does not rotate.

The lubricating liquid line 42 can also be utilized to form the lubricating liquid film between the rotating shaft 2 and the hydrostatic liquid bearing 71 before starting up the turbomachine 101. The lubricating liquid L is supplied to the bearing clearance between the hydrostatic liquid bearing 71 and the rotating shaft 2 by using the lubricating liquid line 42 before starting up of the turbomachine 101, and this levitates the rotating shaft 2 with respect to the hydrostatic liquid bearing 71. Thus, the contact between the rotating shaft 2 and the hydrostatic liquid bearing 71 can be prevented at the time of the start-up.

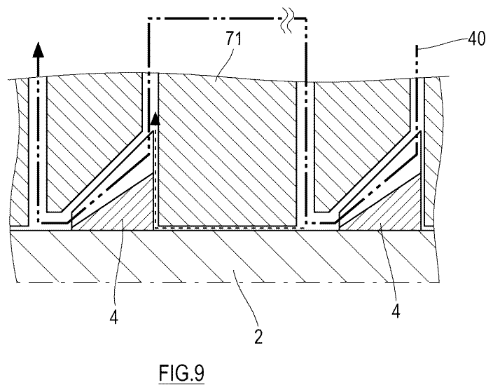

The hydrostatic liquid bearing 71 may serve as a seal that suppresses internal leakage of the mainstream line 40 through which the mainstream of the working fluid W flows. As shown in FIG. 9, the hydrostatic liquid bearing 71 is located between the first bladed wheel 4 at a high-pressure stage and the first bladed wheel 4 at a low-pressure stage, and to reduce the leakage of the working fluid W from the high-pressure stage to the low-pressure stage, there is a minute clearance between the hydrostatic liquid bearing 71 and the rotating shaft 2 in the radial direction. This clearance is filled with a minute amount of working fluid W which has leaked from a passage passing through the first bladed wheel 4 at the high-pressure stage in the mainstream line 40. The hydrostatic liquid bearing 71 serves as a seal that reduces the leakage of the working fluid W from the high-pressure stage to the low-pressure stage, and the hydrostatic liquid bearing 71 and the rotating shaft 2 are separated from each other by the Lomakin effect and are in a non-contact state.

Referring back to FIGS. 1 and 2, in the bearing region 32a of the gas chamber 32, two hydrostatic gas bearings 61 are located away from each other in the axial direction X. The two hydrostatic gas bearings 61 are journal bearings that rotatably support the rotating shaft 2. Moreover, hydrostatic gas bearings 63 are located between the two hydrostatic gas bearings 61 in the axial direction X in the bearing region 32a. The hydrostatic gas bearings 63 are thrust bearings that support a thrust load generated at the rotating shaft 2 in the axial direction X. When the turbomachine 101 includes a known thrust reducer, the hydrostatic gas bearings 63 may be omitted.

The turbomachine 101 includes a lubricating gas line 60 through which a lubricating gas G flows. The lubricating gas G is a gas that is the same in type as the working fluid W. For example, when the working fluid W is liquid hydrogen, the lubricating gas G is a hydrogen gas. Moreover, when the working fluid W is a liquefied natural gas, the lubricating gas G is a natural gas. The lubricating gas G may be a vaporized gas of the working fluid W or may be the working fluid W in a gas state before the working fluid W is supplied to the mainstream line 40.

The lubricating gas G flowing through the lubricating gas line 60 is supplied to the hydrostatic gas bearings 61 and 63 (more specifically, through the hydrostatic gas bearings 61 and 63 to the bearing clearances between the rotating shaft 2 and the hydrostatic gas bearings 61 and 63), discharged from the hydrostatic gas bearings 61 and 63 to the bearing region 32a, and then discharged to the outside of the bearing region 32a.

Lubricating gas films are formed between the rotating shaft 2 and the hydrostatic gas bearings 61 and 63 by the lubricating gas G supplied to the bearing clearances between the rotating shaft 2 and the hydrostatic gas bearings 61 and 63. The rotating shaft 2 and the hydrostatic gas bearings 61 and 63 are separated from each other by the lubricating gas films and are in a non-contact state. The supply pressure of the lubricating gas G to be supplied to the hydrostatic gas bearings 61 and 63 is controlled by a lubricating gas supply pressure control valve 65 located at a portion of the lubricating gas line 60 which is located upstream of the hydrostatic gas bearings 61 and 63. The bearing stiffnesses of the hydrostatic gas bearings 61 and 63 can be adjusted in such a manner that the lubricating gas supply pressure control valve 65 adjusts the supply pressure of the lubricating gas G.

The bearing region 32a of the gas chamber 32 is in an atmosphere of a vaporization condition of the lubricating gas G. The lubricating gas G in the bearing region 32a forms bearing back pressure of the hydrostatic gas bearings 61 and 63. By applying the appropriate bearing back pressure to the hydrostatic gas bearings 61 and 63, appropriate no-load clearances are formed between the rotating shaft 2 and the hydrostatic gas bearings 61 and 63. The bearing back pressure is controlled by a back pressure control valve 66 located at a portion of the lubricating gas line 60 which is located downstream of the gas chamber 32.

In the load region 32b of the gas chamber 32, a second bladed wheel 5 is attached to the rotating shaft 2. In the present embodiment, the second bladed wheel 5 is a brake bladed wheel that brakes the rotation of the rotating shaft 2. In the load region 32b, a heat exchanger 51 and a differential pressure control valve 52 are located in addition to the second bladed wheel 5. The differential pressure control valve 52 is a valve whose opening degree changes by the differential pressure.

The turbomachine 101 includes a load gas circulation line 50 through which a braking gas flows as a load gas in the load region 32b of the gas chamber 32. The load gas is the same in type as the working fluid W and is also the same in type as the lubricating gas G. For example, when the working fluid W is liquid hydrogen, the load gas is a hydrogen gas. Moreover, when the working fluid W is a liquefied natural gas, the load gas is a natural gas. After the load gas flowing through the load gas circulation line 50 acts on the second bladed wheel 5, the load gas is cooled by the heat exchanger 51. Then, the load gas flows through the differential pressure control valve 52 and flows into the second bladed wheel 5 again. A load gas supply line 53 that supplies the load gas to the load gas circulation line 50 is connected to the load gas circulation line 50. A second region pressure control valve 55 that controls the pressure of the load gas in the load region 32b is located at the load gas circulation line 50. The second region pressure control valve 55 controls the pressure in the load region 32b so as to reduce the gas that leaks from the bearing region 32a of the gas chamber 32 through the labyrinth seal 26 to the load region 32b of the gas chamber 32.

The following will describe the operation of the turbomachine 101 as an expansion turbine. The working fluid W is supplied to the mainstream line 40 of the turbomachine 101 from the outside. The working fluid W supplied to the mainstream line 40 is in a cryogenic high-pressure liquid state or in a cryogenic high-pressure gas-liquid two-phase state. The working fluid W flowing through the mainstream line 40 sequentially acts on the first bladed wheels 4 and is then discharged from the liquid chamber 31. The working fluid W which has acted on the first bladed wheels 4 imparts swirl energy to the first bladed wheels 4 by its fluid pressure, and therefore, the working fluid W expands and is reduced in temperature. The working fluid W discharged from the liquid chamber 31 is in a liquid state.

During the operation of the turbomachine 101, the rotating shaft 2 rotates at an ultra-high speed by the swirl energy imparted to the first bladed wheels 4, and accordingly, the second bladed wheel 5 rotates. The load gas supplied to the second bladed wheel 5 is compressed by the rotation of the second bladed wheel 5, and thus, the load gas increases in temperature and pressure. After the load gas is reduced in temperature and pressure by the heat exchanger 51 and the differential pressure control valve 52, the load gas is supplied to the second bladed wheel 5 again. The pressure of the load gas at an outlet of the heat exchanger 51 and the pressure of the load gas at an inlet of the second bladed wheel 5 are controlled to be constant by the differential pressure control valve 52.

During the operation of the turbomachine 101, by the lubricating gas G supplied to the bearing clearances between the rotating shaft 2 and the hydrostatic gas bearings 61 and 63, a radial load of the rotating shaft 2 that is rotating is supported by the hydrostatic gas bearings 61 in a non-contact manner, and a thrust load of the rotating shaft 2 that is rotating is supported by the hydrostatic gas bearings 63 in a non-contact manner. Moreover, by the lubricating liquid L supplied to the bearing clearance between the hydrostatic liquid bearing 71 and the rotating shaft 2, the radial load of the rotating shaft 2 that is rotating is supported by the hydrostatic liquid bearing 71 in a non-contact manner.

The lubricating liquid L is part of the working fluid W which has been extracted from the mainstream of the working fluid W. The lubricating liquid L is utilized at the hydrostatic liquid bearing 71 to support the rotating shaft 2, absorbs heat loss generated at the hydrostatic liquid bearing 71, and returns to the mainstream of the working fluid W. Since the lubricating liquid L which has returned from the hydrostatic liquid bearing 71 is mixed with the mainstream of the working fluid W, the mainstream of the working fluid W receives heat input. When at least one of the hydrostatic bearings included in the turbomachine 101 is the hydrostatic liquid bearing 71, the heat input to the mainstream of the working fluid W can be made smaller than that when all of the hydrostatic bearings are the hydrostatic liquid bearings.

Moreover, the usage amount of working fluid W converted to mass flow rate by the hydrostatic liquid bearing 71 is smaller than that by each of the hydrostatic gas bearings 61 and 63. Therefore, when at least one of the hydrostatic bearings included in the turbomachine 101 is the hydrostatic liquid bearing 71, the usage amount of working fluid W converted to mass flow rate can be made smaller than that when all of the hydrostatic bearings are the hydrostatic gas bearings.

Furthermore, the hydrostatic gas bearings 61 and 63 can levitate the rotating shaft 2 at the start and end of the rotation of the rotating shaft 2. Therefore, the rotating shaft 2 is more satisfactorily supported by the bearings at the start and end of the rotation of the rotating shaft 2 than when all of the hydrostatic bearings included in the turbomachine 101 are the hydrostatic liquid bearings. Therefore, an additional bearing used at the start and end of the rotation of the rotating shaft 2 is unnecessary unlike when all of the hydrostatic bearings are the hydrostatic liquid bearing.

In Embodiment 1, the second bladed wheel 5 is the brake bladed wheel that brakes the rotating shaft 2. However, the second bladed wheel 5 may be a driving bladed wheel that drives the rotating shaft 2. In this case, a high-pressure driving gas is supplied as the load gas to the load region 32b of the gas chamber 32. The supplied driving gas can apply rotational force to the rotating shaft 2 by acting on the second bladed wheel 5, that is, by imparting the swirl energy to the second bladed wheel 5.

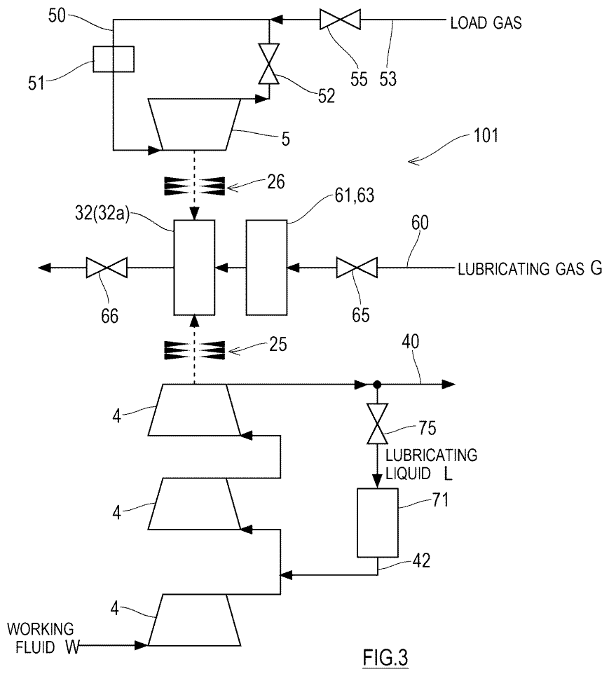

Moreover, in Embodiment 1, the turbomachine 101 is the expansion turbine. However, the turbomachine 101 may be a pump. In this case, as shown in FIG. 3, the turbomachine 101 that is the pump is different from the expansion turbine shown in FIG. 2 in that: the high-pressure driving gas as the load gas flows through the load gas circulation line 50 and the load gas supply line 53; and the direction of the flow of the working fluid W in the mainstream line 40 is opposite. The other components are substantially the same as each other. The turbomachine 101 that is the pump is supplied with the load gas through the load gas supply line 53, and the second bladed wheel 5 is rotated by the circulation of the load gas in the load gas circulation line 50. By the rotation of the second bladed wheel 5, the rotating shaft 2 and the first bladed wheels 4 are rotated. Thus, the working fluid W in a liquid state or a gas-liquid two-phase state is drawn into the liquid chamber 31 through the second port 37, sequentially acts on the first bladed wheels 4 and is compressed, and is discharged through the first port 36 to the outside of the liquid chamber 31. The working fluid W discharged from the liquid chamber 31 is in a liquid state. The lubricating liquid L supplied to the hydrostatic liquid bearing 71 is part of the working fluid W extracted from the mainstream of the working fluid W. The lubricating liquid L is utilized at the hydrostatic liquid bearing 71 to support the rotating shaft 2, absorbs the heat loss generated at the hydrostatic liquid bearing 71, and returns to the mainstream of the working fluid W.

### Embodiment 2

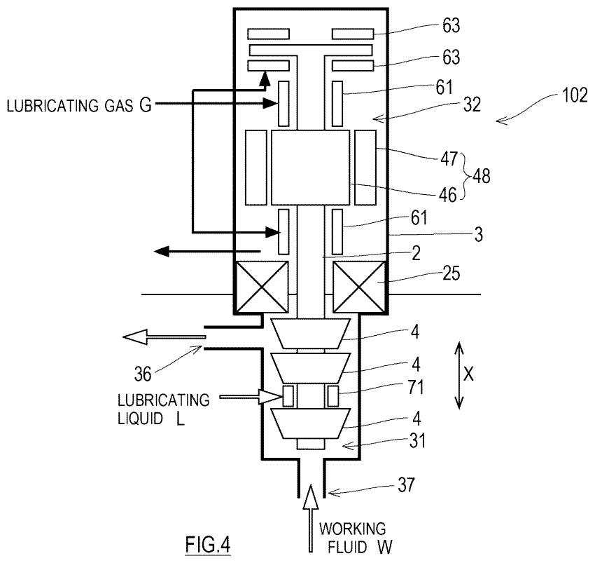

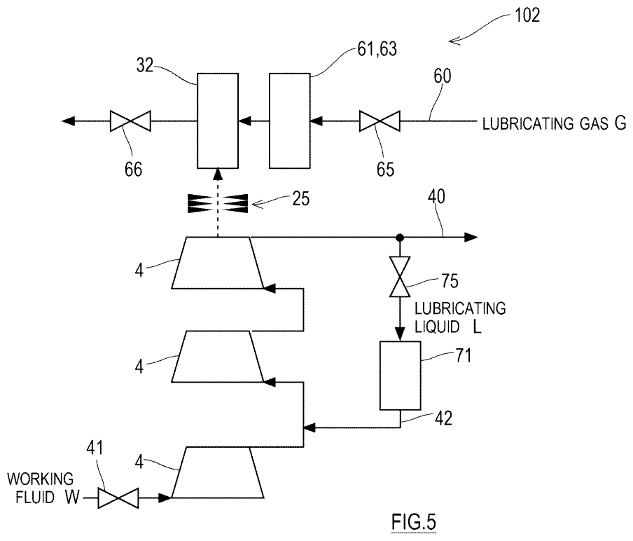

Next, Embodiment 2 of the present disclosure will be described. FIG. 4 is a schematic configuration diagram of a turbomachine 102 according Embodiment 2 of the present disclosure. FIG. 5 is a diagram for explaining the flow of the fluid in the turbomachine 102 shown in FIG. 4. In the description of the present embodiment, components that are the same as or similar to those in the above embodiment are denoted by the same reference signs in the drawings, and detailed explanations thereof are omitted.

As shown in FIGS. 4 and 5, in the present embodiment, the pump is adopted as one example of the turbomachine 102, and the characteristic configuration of the turbomachine 102 according to the present disclosure will be described by being applied to the pump. The pump is used to pressurize and deliver a cryogenic liquefied gas, such as liquid hydrogen or a liquefied natural gas.

The turbomachine 102 includes the casing 3 and the rotating shaft 2 accommodated in the casing 3. The casing 3 includes the liquid chamber 31 and the gas chamber 32 which are lined up in the axial direction X. The rotating shaft 2 penetrates the liquid chamber 31 and the gas chamber 32.

In the liquid chamber 31, the first bladed wheels 4 are attached to the rotating shaft 2. The first bladed wheels 4 are lined up in the axial direction X. Moreover, the hydrostatic liquid bearing 71 is located in the liquid chamber 31. The hydrostatic liquid bearing 71 is a journal bearing that rotatably supports the rotating shaft 2. The turbomachine 101 shown in FIG. 4 includes three first bladed wheels 4, and the hydrostatic liquid bearing 71 is located between the first bladed wheel 4 at the second stage and the first bladed wheel 4 at the third stage in the axial direction X.

The turbomachine 102 includes the mainstream line 40 through which the working fluid W flows. The working fluid W flowing through the mainstream line 40 is drawn into the liquid chamber 31 through the second port 37, sequentially acts on the first bladed wheels 4 and is compressed, and is discharged through the first port 36 to the outside of the liquid chamber 31.

The lubricating liquid L is supplied to the bearing clearance between the hydrostatic liquid bearing 71 and the rotating shaft 2. The lubricating liquid L is a fluid that is the same in type as the working fluid W and is in a liquid state or a gas-liquid two-phase state. The lubricating liquid line 42 is connected to the mainstream line 40. In the present embodiment, the upstream end of the lubricating liquid line 42 is connected to a portion of the mainstream line 40 which is located upstream of the mainstream control valve 41, and the downstream end of the lubricating liquid line 42 is connected to a portion of the mainstream line 40 which is located between the first bladed wheel 4 at the second stage and the first bladed wheel 4 at the third stage. The lubricating liquid line 42 extracts part of the working fluid W from the mainstream line 40, supplies the working fluid W as the lubricating liquid L to the hydrostatic liquid bearing 71, returns the lubricating liquid L, which has been used at the hydrostatic liquid bearing 71 and discharged, to the mainstream line 40.

Two hydrostatic gas bearings 61 are located in the gas chamber 32. The two hydrostatic gas bearings 61 are radial bearings that rotatably support the rotating shaft 2. The two hydrostatic gas bearings 61 are located away from each other in the axial direction X. Moreover, the hydrostatic gas bearings 63 are located in the gas chamber 32. The hydrostatic gas bearings 63 are thrust bearings that support the thrust load generated at the rotating shaft 2 in the axial direction X.

The turbomachine 102 includes the lubricating gas line 60 through which the lubricating gas G flows. The lubricating gas G is a gas that is the same in type as the working fluid W. The lubricating gas G flowing through the lubricating gas line 60 is supplied to the hydrostatic gas bearings 61 and 63, discharged from the hydrostatic gas bearings 61 and 63 to the gas chamber 32, and then discharged to the outside of the gas chamber 32. The supply pressure of the lubricating gas G to be supplied to the hydrostatic gas bearings 61 and 63 is controlled by the lubricating gas supply pressure control valve 65 located at a portion of the lubricating gas line 60 which is located upstream of the hydrostatic gas bearings 61 and 63. The gas chamber 32 is in an atmosphere of a vaporization condition of the lubricating gas G. The lubricating gas G in the gas chamber 32 forms the bearing back pressure of the hydrostatic gas bearings 61 and 63. The bearing back pressure is controlled by the back pressure control valve 66 located at a portion of the lubricating gas line 60 which is located downstream of the gas chamber 32.

In the gas chamber 32, a rotor 46 is attached to the rotating shaft 2. The rotor 46 is located between the two hydrostatic gas bearings 61 in the axial direction X. Moreover, in the gas chamber 32, a stator 47 is located around the rotor 46. The rotor 46 and the stator 47 constitute an electric motor 48 that rotates the rotating shaft 2.

The gas-liquid seal 25 is located between the liquid chamber 31 and the gas chamber 32 in the axial direction X. The gas-liquid seal 25 seals a clearance between the rotating shaft 2 and the casing 3 in the radial direction. The gas-liquid seal 25 prevents the fluid from moving from the liquid chamber 31 to the gas chamber 32 and from the gas chamber 32 to the liquid chamber 31. Moreover, the gas-liquid seal 25 has the heat insulation property and prevents the heat conduction between the liquid chamber 31 and the gas chamber 32.

The following will describe the operation of the turbomachine 102 as a pump. When the rotating shaft 2 is rotated by the operation of the electric motor 48, the working fluid W is drawn through the second port 37 into the liquid chamber 31 and is increased in pressure by the first bladed wheels 4 that are rotating. The working fluid W that has been increased in pressure is discharged through the first port 36.

During the operation of the turbomachine 102, the rotating shaft 2 rotates at high speed by the energy imparted from the electric motor 48 to the rotating shaft 2. By the lubricating gas G supplied to the bearing clearances between the rotating shaft 2 and the hydrostatic gas bearings 61 and 63, the radial load of the rotating shaft 2 that is rotating is supported by the hydrostatic gas bearings 61 in a non-contact manner, and the thrust load of the rotating shaft 2 that is rotating is supported by the hydrostatic gas bearings 63 in a non-contact manner. By the lubricating liquid L supplied to the bearing clearance between the hydrostatic liquid bearing 71 and the rotating shaft 2, the radial load of the rotating shaft 2 that is rotating is supported by the hydrostatic liquid bearing 71 in a non-contact manner.

### Modified Example 1

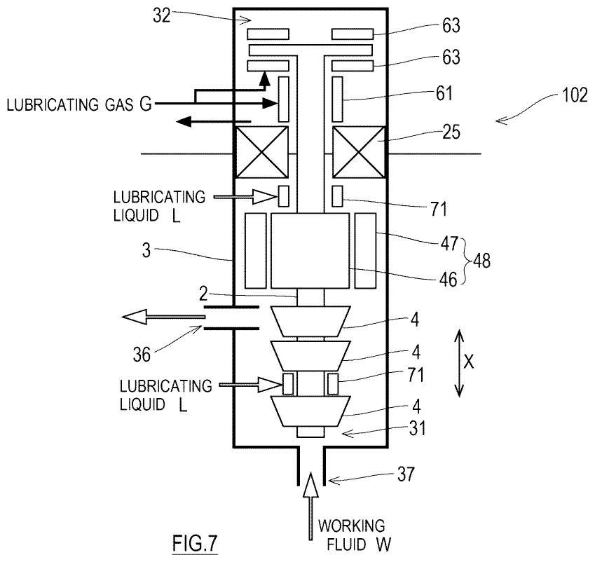

The following will describe Modified Example 1 of the turbomachine 102 according to Embodiment 2. In the turbomachine 102 according to Embodiment 2, the electric motor 48 is located in the gas chamber 32. However, the electric motor 48 may be located in the liquid chamber 31. FIG. 7 is a diagram showing the schematic configuration of the turbomachine 102 according to Modified Example 1 of Embodiment 2. In the description of the present modified example, components that are the same as or similar to those in the above embodiment are denoted by the same reference signs in the drawings, and detailed explanations thereof are omitted.

As shown in FIG. 7, in the turbomachine 102 according to Modified Example 1, the casing 3 includes the liquid chamber 31 and the gas chamber 32. In the liquid chamber 31, the rotor 46 is attached to the rotating shaft 2. In the liquid chamber 31, the stator 47 is located around the rotor 46. As above, in the present modified example, the electric motor 48 including the rotor 46 and the stator 47 is immersed in the working fluid W.

In the present modified example, to support the electric motor 48 that is a relatively heavy object, the hydrostatic liquid bearings 71 that support the radial load of the rotating shaft 2 are located at two positions in the liquid chamber 31. The hydrostatic liquid bearings 71 at two positions are located away from each other in the axial direction X, and the rotor 46 is located between the hydrostatic liquid bearings 71 at two positions.

### Modified Example 2

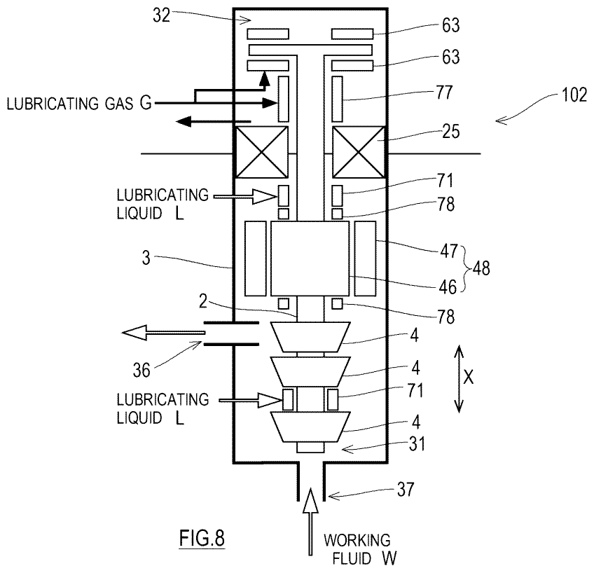

Next, Modified Example 2 of the turbomachine 102 according to Embodiment 2 will be described. The turbomachine 102 according to Modified Example 2 is a modified version of the turbomachine 102 according to Modified Example 1. FIG. 8 is a diagram showing the schematic configuration of the turbomachine 102 according to Modified Example 2 of Embodiment 2. In the turbomachine 102 according to Modified Example 2 shown in FIG. 8, the hydrostatic gas bearings 63 that support the thrust load of the rotating shaft 2 and a journal bearing 77 that supports the radial load of the rotating shaft 2 are located in the gas chamber 32. The journal bearing 77 is a hydrodynamic gas bearing or an active magnetic bearing and is not a hydrostatic gas bearing. As above, the hydrostatic gas bearing is used only as the thrust bearing that is relatively large in the amount of heat generated, and the journal bearing is the journal bearing 77 that is of a type other than the hydrostatic gas bearing. Thus, the usage amount of lubricating gas G can be reduced. When the lubricating gas G is the vaporized gas of the working fluid W, and the lubricating gas G that has been used returns to the mainstream of the working fluid W, the amount of heat input to the mainstream of the working fluid W can be reduced.

Moreover, in the turbomachine 102 according to Modified Example 2, journal bearings 78 that support the radial load of the rotating shaft 2 are located in the liquid chamber 31 in addition to the hydrostatic liquid bearings 71. The journal bearings 78 are hydrodynamic liquid bearings, active bearings, or rolling bearings and are not hydrostatic liquid bearings. At the start and end of the rotation of the rotating shaft 2, the differential pressure is not generated at the hydrostatic liquid bearings 71, and therefore, the hydrostatic liquid bearings 71 cannot levitate the rotating shaft 2. However, since the journal bearings 78 that are of a type other than the hydrostatic liquid bearings are additionally included in the liquid chamber 31, the rotating shaft 2 can be satisfactorily supported by the journal bearings 78 at the start and end of the rotation of the rotating shaft 2.

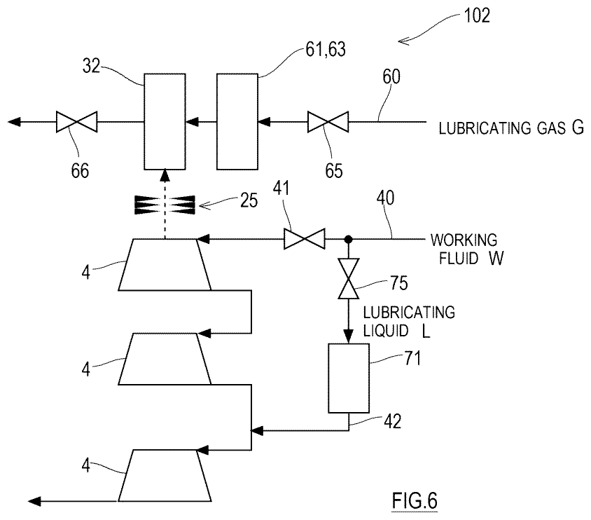

Moreover, in Embodiment 2, the turbomachine 102 is the pump. However, the turbomachine 102 may be the expansion turbine. In this case, as shown in FIG. 6, the turbomachine 102 that is the expansion turbine is different from the pump shown in FIG. 5 in that the direction of the flow of the working fluid W in the mainstream line 40 is opposite. Moreover, the electric motor 48 including the rotor 46 and the stator 47 is a power generator. In the turbomachine 102 that is the expansion turbine, the working fluid W in a cryogenic high-pressure liquid state or a cryogenic high-pressure gas-liquid two-phase state is supplied to the mainstream line 40. The working fluid W flowing through the mainstream line 40 sequentially acts on the first bladed wheels 4 and is then discharged from the liquid chamber 31. The working fluid W which has acted on the first bladed wheels 4 imparts swirl energy to the first bladed wheels 4 by its fluid pressure, and therefore, the working fluid W expands, is reduced in temperature, becomes a liquid state, and is discharged from the liquid chamber 31.

### Conclusion

Each of the turbomachines 101 and 102 according to a first aspect of the present disclosure includes:
the rotating shaft 2;
the casing 3 including the liquid chamber 31 and the gas chamber 32 in which the rotating shaft 2 extends;
the hydrostatic liquid bearing 71 located in the liquid chamber 31 and supporting the rotating shaft 2 through the lubricating liquid L supplied to the bearing clearance between the hydrostatic liquid bearing 71 and the rotating shaft 2; and
the hydrostatic gas bearings 61 and 63 located in the gas chamber 32 and supporting the rotating shaft 2 through the lubricating gas G supplied to the bearing clearances between the rotating shaft 2 and the hydrostatic gas bearings 61 and 63.

In each of the turbomachines 101 and 102 configured as above, when part of the working fluid W which has been pressurized by the rotation of the rotating shaft 2 is used as the lubricating liquid L, the hydrostatic liquid bearing 71 may not be able to obtain adequate bearing strength for supporting the rotating shaft 2 at the start and end of the rotation of the rotating shaft 2, but the rotating shaft 2 and the hydrostatic gas bearings 61 and 63 are separated from each other at all times by the lubricating gas films and are in a non-contact state. Therefore, even at the start and end of the rotation of the rotating shaft 2, the rotating shaft 2 can be prevented from contacting the hydrostatic liquid bearing 71 and the hydrostatic gas bearings 61 and 63. Thus, an additional bearing used at the start and end of the rotation of the rotating shaft 2 is unnecessary. Moreover, when at least one of the hydrostatic bearings included in each of the turbomachines 101 and 102 is the hydrostatic liquid bearing 71, the usage amount of working fluid W converted to mass flow rate can be made smaller than that when all of the hydrostatic bearings are the hydrostatic gas bearings.

Each of the turbomachines 101 and 102 according to a second aspect of the present disclosure is configured such that each of the turbomachines 101 and 102 according to the first aspect includes:
the first bladed wheels 4 attached to the rotating shaft 2 in the liquid chamber 31;
the mainstream line 40 that makes the working fluid W, which has been supplied to an inlet of the liquid chamber 31 and is in a liquid state or a gas-liquid two-phase state, act on the first bladed wheels 4 and then guides the working fluid W to an outlet of the liquid chamber 31; and
the lubricating liquid line 42 that extracts part of the working fluid W from the mainstream line 40, supplies the working fluid W as the lubricating liquid L to the hydrostatic liquid bearing 71, and returns the lubricating liquid L, which has been discharged from the hydrostatic liquid bearing 71, to the mainstream line 40.

In each of the turbomachines 101 and 102 configured as above, the lubricating liquid L is part of the working fluid W which has been extracted from the mainstream of the working fluid W. Therefore, an external pressure booster that supplies the lubricating liquid L to the hydrostatic liquid bearing 71 becomes unnecessary. Moreover, the lubricating liquid L is utilized at the hydrostatic liquid bearing 71 to support the rotating shaft 2, absorbs the heat loss generated at the hydrostatic liquid bearing 71, and returns to the mainstream of the working fluid W. Since the lubricating liquid L which has returned from the hydrostatic liquid bearing 71 is mixed with the mainstream of the working fluid W, the mainstream of the working fluid W receives the heat input. When at least one of the hydrostatic bearings included in the turbomachine 101 is the hydrostatic liquid bearing 71, the heat input to the mainstream of the working fluid W can be made smaller than that when all of the hydrostatic bearings are the hydrostatic liquid bearings.

Each of the turbomachines 101 and 102 according to a third aspect of the present disclosure is configured such that in the turbomachine 101 according to the first or second aspect, the lubricating liquid line 42 includes the pressure control valve 75 that controls the supply pressure of the lubricating liquid L to be supplied to the hydrostatic liquid bearing 71.

In each of the turbomachines 101 and 102 configured as above, the bearing stiffness of the hydrostatic liquid bearing 71 can be adjusted by the adjustment of the supply pressure of the lubricating liquid L to be supplied to the hydrostatic liquid bearing 71. Therefore, the bearing stiffness of the hydrostatic liquid bearing 71 can be adjusted in accordance with the operation state of each of the turbomachines 101 and 102.

Each of the turbomachines 101 and 102 according to a fourth aspect of the present disclosure is configured such that: each of the turbomachines 101 and 102 according to the second or third aspect further includes the gas-liquid seal 25 that separates the liquid chamber 31 and the gas chamber 32 from each other; the hydrostatic liquid bearing 71 is the journal bearing; and the number of first bladed wheels 4 located between the hydrostatic liquid bearing 71 and the gas-liquid seal 25 is at least one.

As above, the vicinity of a portion of the rotating shaft 2 at which the first bladed wheel 4 on which the mainstream of the working fluid W acts is located is supported by the hydrostatic liquid bearing 71. Therefore, the radial load acting on the rotating shaft 2 is reduced, and thus, the first bladed wheel 4 can rotate at high speed, and the number of first bladed wheels 4 can be increased. Moreover, since the hydrostatic liquid bearing 71 is located at a further shaft end side, the rigid body natural frequency and first bending critical speed of the rotating shaft 2 can be increased, and thus, the first bladed wheel 4 can rotate at high speed, and the number of first bladed wheels 4 can be increased.

Each of the turbomachines 101 and 102 according to a fifth aspect of the present disclosure is configured such that each of the turbomachines 101 and 102 according to any one of the first to third aspects further includes the gas-liquid seal 25 that is located between the hydrostatic liquid bearing 71 and the hydrostatic gas bearings 61 and 63 and separates the liquid chamber 31 and the gas chamber 32 from each other.

The leakage of the fluid between the liquid chamber 31 and the gas chamber 32 is prevented by the gas-liquid seal 25. Thus, a gas is prevented from being mixed with the working fluid W in the liquid chamber 31, and the flow of the mainstream of the working fluid W in the liquid chamber 31 can be stabilized.

Each of the turbomachines 101 and 102 according to a sixth aspect of the present disclosure is configured such that in each of the turbomachines 101 and 102 according to the fifth aspect, the gas-liquid seal 25 has the heat insulating property.

Thus, the heat input from the gas chamber 32 to the working fluid W flowing through the liquid chamber 31 can be reduced.

The turbomachine 101 according to a seventh aspect of the present disclosure is configured such that: in the turbomachine 101 according to any one of the first to sixth aspects, the gas chamber 32 of the casing 3 includes the first region 32a which is filled with the lubricating gas G and in which the hydrostatic gas bearings 61 and 63 are located and the second region 32b which is filled with a gas that is the same in type as the lubricating gas G; and the turbomachine 101 further includes the second bladed wheel 5 that is attached to the rotating shaft 2 in the second region 32b of the gas chamber 32 and drives or brakes the rotating shaft 2.

Since the second bladed wheel 5 that drives the rotating shaft 2 is included, rotational force can be applied to the rotating shaft 2. Moreover, since the second bladed wheel 5 that brakes the rotating shaft 2 is included, rotational energy of the rotating shaft 2 can be taken out. Then, since the second bladed wheel 5 is located in the gas chamber 32, the heat input to the working fluid W flowing through the liquid chamber 31 can be reduced.

The turbomachine 101 according to an eighth aspect of the present disclosure is configured such that: in the turbomachine 101 according to the seventh aspect, the first and second regions 32a and 32b of the gas chamber 32 are separated from each other by the seal 26; the turbomachine 101 includes the back pressure control valve 66 that controls the bearing back pressure of the hydrostatic gas bearings 61 and 63, the bearing back pressure being generated by the lubricating gas G of the first region 32a, the second region pressure control valve 55 that controls the pressure in the second region 32b, and the lubricating gas supply pressure control valve 65 that controls the supply pressure of the lubricating gas G to be supplied to the hydrostatic gas bearings 61 and 63; and the back pressure control valve 66, the second region pressure control valve 55, and the lubricating gas supply pressure control valve 65 are independently controllable.

The pressure in the mainstream line 40 and the pressure in the load region 32b that is the second region of the gas chamber 32 (i.e., the pressure in the load gas circulation line 50) change depending on the operation state of the turbomachine 101. Even in the case of such pressure changes, the bearing back pressure of the hydrostatic gas bearings 61 and 63, the pressure in the second region 32b, and the supply pressure of the lubricating gas G are individually adjusted, and therefore, the leakage of the fluid from the load region 32b of the gas chamber 32 to the bearing region 32a of the gas chamber 32, the leakage of the fluid from the liquid chamber 31 to the bearing region 32a, and the leakage of the fluid from the bearing region 32a to the liquid chamber 31 can be prevented while securing the bearing stiffnesses of the hydrostatic gas bearings 61 and 63.

The turbomachine 102 according to a ninth aspect of the present disclosure is configured such that the turbomachine 102 according to any one of the first to sixth aspects further includes the electric motor 48 or the power generator including the rotor 46 attached to the rotating shaft 2 in the gas chamber 32 and the stator 47 located in the gas chamber 32.

Since the electric motor 48 or the power generator is located in the gas chamber 32, the heat input to the working fluid W flowing through the liquid chamber 31 can be reduced.

The foregoing discussion of the present disclosure has been presented for purposes of illustration and description. The foregoing is not intended to limit the present disclosure to the form or forms disclosed herein. In the foregoing Detailed Description for example, various features of the present disclosure are grouped together in some embodiments for the purpose of streamlining the disclosure. However, some of the features may be combined with each other. Moreover, the features of the present disclosure may be combined in alternate embodiments, configurations, or aspects other than those discussed above.

1. A turbomachine comprising:
a rotating shaft;
a casing including a liquid chamber and a gas chamber in which the rotating shaft extends;
a hydrostatic liquid bearing located in the liquid chamber and supporting the rotating shaft through a lubricating liquid supplied to a bearing clearance between the hydrostatic liquid bearing and the rotating shaft; and
a hydrostatic gas bearing located in the gas chamber and supporting the rotating shaft through a lubricating gas supplied to a bearing clearance between the hydrostatic gas bearing and the rotating shaft.

2. The turbomachine according to claim 1, further comprising:
a first bladed wheel attached to the rotating shaft in the liquid chamber;
a mainstream line that makes a working fluid, which has been supplied to an inlet of the liquid chamber and is in a liquid state or a gas-liquid two-phase state, act on the first bladed wheel and then guides the working fluid to an outlet of the liquid chamber; and
a lubricating liquid line that extracts part of the working fluid from the mainstream line, supplies the working fluid as the lubricating liquid to the hydrostatic liquid bearing, and returns the lubricating liquid, which has been discharged from the hydrostatic liquid bearing, to the mainstream line.

3. The turbomachine according to claim 2, wherein the lubricating liquid line includes a pressure control valve that controls supply pressure of the lubricating liquid to be supplied to the hydrostatic liquid bearing.

4. The turbomachine according to claim 2, further comprising a gas-liquid seal that separates the liquid chamber and the gas chamber from each other, wherein:
the hydrostatic liquid bearing is a journal bearing; and
the number of first bladed wheels located between the hydrostatic liquid bearing and the gas-liquid seal is at least one.

5. The turbomachine according to claim 1, further comprising a gas-liquid seal that is located between the hydrostatic gas bearing and the hydrostatic liquid bearing and separates the liquid chamber and the gas chamber from each other.

6. The turbomachine according to claim 5, wherein the gas-liquid seal has a heat insulating property.

7. The turbomachine according to claim 1, wherein the gas chamber of the casing includes a first region which is filled with the lubricating gas and in which the hydrostatic gas bearing is located and a second region which is filled with a gas that is the same in type as the lubricating gas,
the turbomachine further comprising a second bladed wheel that is attached to the rotating shaft in the second region of the gas chamber and drives or brakes the rotating shaft.

8. The turbomachine according to claim 7, wherein the first and second regions of the gas chamber are separated from each other by a seal,
the turbomachine further comprising:
a back pressure control valve that controls bearing back pressure of the hydrostatic gas bearing, the bearing back pressure being generated by the lubricating gas of the first region;
a second region pressure control valve that controls pressure in the second region; and
a lubricating gas supply pressure control valve that controls supply pressure of the lubricating gas to be supplied to the hydrostatic gas bearing, wherein
the back pressure control valve, the second region pressure control valve, and the lubricating gas supply pressure control valve are independently controllable.

9. The turbomachine according to claim 1, further comprising an electric motor or a power generator including
a rotor attached to the rotating shaft in the gas chamber and
a stator located in the gas chamber.
